(19) United States
(12) Patent Application Publication
(10) Pub. No.: US 2018/0182023 A1
(43) Pub. Date: Jun. 28, 2018

(54) Licktypic

(71) Applicant: Vanessa Anne Mitchell, New York, NY (US)

(72) Inventor: Vanessa Anne Mitchell, New York, NY (US)

(21) Appl. No.: 15/391,826

(22) Filed: Dec. 27, 2016

(51) Int. Cl. G06Q 30/06; G06F 17/30

(52) U.S. Cl. CPC G06Q 30/0643; G06F 17/30247

(57) ABSTRACT

Lickty pic is used as a buying tool of an item/thing that is physically in front of you that you wish to buy by taking a photograph of it, you can purchase the thing/item or similar items that are returned in the results. If you wish to find out more information on similar or same objects you've photographed Lickty pic can do this too, narrowing down options and will present results back in image form also, you then can choose one or more of the result images to be transferred to that website.

### CROSS REFERENCE TO RELATED APPLICATIONS

Application number reference Ser. No. 15/391,826 for Lickty pic, inventor vanessa mitchell, New York

### STATEMENT REGARDING FEDERALLY SPONSORED RESEARCH OR DEVELOPMENT

N/A

### BACKGROUND OF LICKTYPIC

I had broken my sunglasses and loved the shape and design of my sunglasses. I spent hours at night for weeks typing in all sorts of details, square with slight rounded edges, black sunglasses. Many many descriptions, with no results of what i was looking for. i had them in my hand and starting talking to the computer saying “if you could only see what i'm holding in my hand this wouldn't be an issue” Then i realized if i could take a picture of the sunglasses and search then this wouldn't be an issue. I searched online for apps programs to allow me to do this, without any results. I decided i was going to make my own app that allows me to take a picture of anything and search whether it's hardwood floors, sunglasses, vitamins etc. For more information or to have the option to buy what i'm looking for. I then applied for my provisional patent (application no. 62/271,242). Researched for app programmers, got a non-disclosure signed by my programmer and went ahead and made Licktypic. Which was accepted by Apple store in March 2016.

### BRIEF SUMMARY OF MY INVENTION LICKTY PIC

Lickty Pic is a image to image search with the added bonus of buying what you took a picture of through your phone camera.

Licktypic app requires no typing to search for what you want

Licktypic has 2 options—one option is a regular search of images, or the second option is to strictly buy the item/thing you have taken a picture of. FIG. 1 (a) and (b) Page 13

### BRIEF DESCRIPTION OF SEVERAL VIEWS OF DRAWINGS FOR LICKTY PIC

FIG. 1 (a) and (b) Page. 13

Lickty pic has 2 options of searching

FIG. 1a. is a regular search for same or similar images of your item/thing

FIG. 1b. is the option to buy the item/thing you have taken a photo of.

FIG. 2. Page 14

Lickty Pic App Layout

Home icon button=return to a fresh blank page

Camera icon=push the camera button to take a picture of your item

$ icon=to look for items to buy only

FIG. 3. Page 15

When you push the camera icon on the bottom of the screen, you are initiating a regular search of the World Wide Web.

Once you have taken a picture of your item an icon “licktypic it” appears this icon is the search button.

After pushing licktypic the search for your image item has begun.

Regular Search (Option 1 of Lickty Pic)

FIG. 4. Page 16

Example—vitamins “bone renewal” was captured with phone camera

FIG. 5. Page 17

Your search image results have appeared.

You now have the option of clicking on a desired image to be transferred to that images origin (website)

If many image results appear you can swipe for more image results.

FIG. 6. Page 18

Example through Lickty pic app “bone renewal” vitamin results from various websites (you can click on each image to be transferred to the images origin website)

Buying Search (2nd Option Lickty Pic Offers)

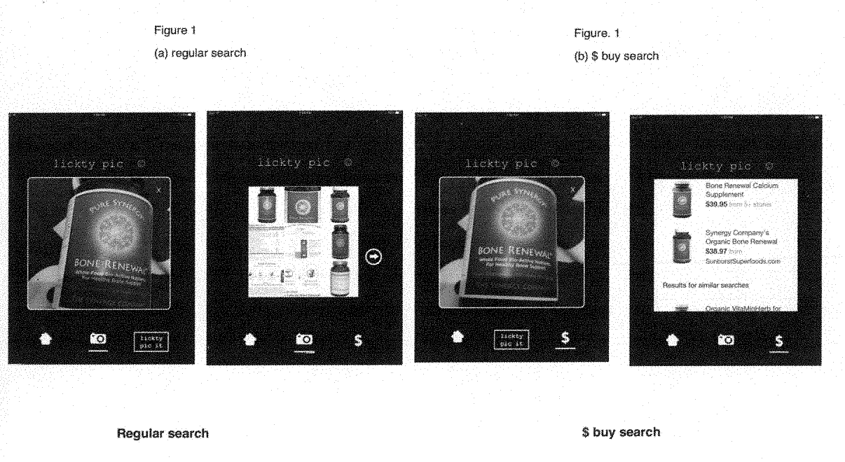

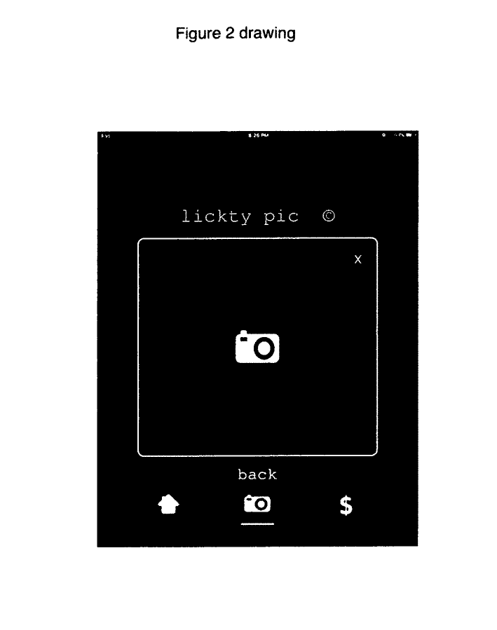

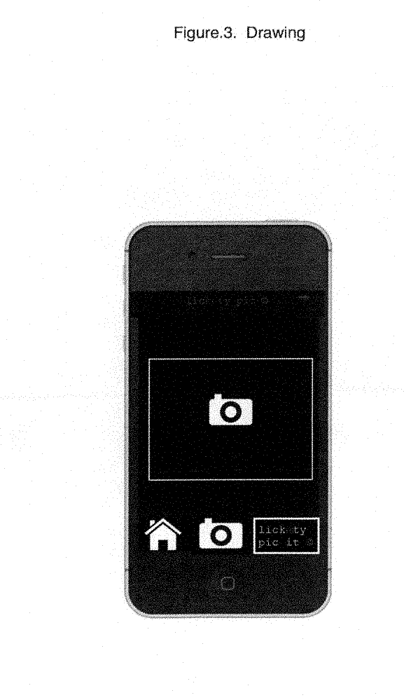

FIG. 1 (b). Page 13

We now want to perform a buying search only. (Items for sale of your image)—this is the 2nd option of Licktypic. FIG. 7 Page 19

FIG. 8. Page 20, And FIG. 7 page 19

Example Vitamins

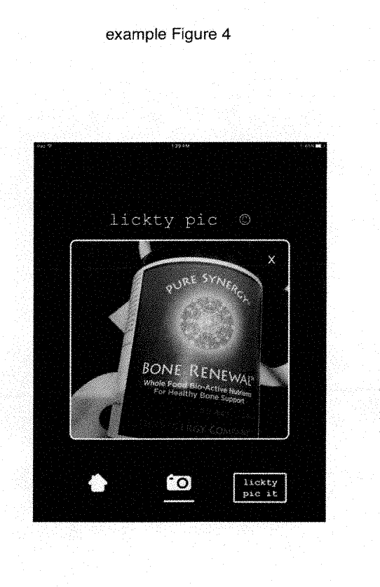

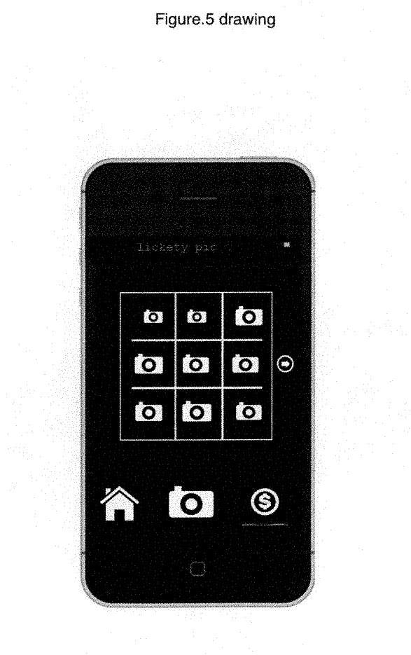

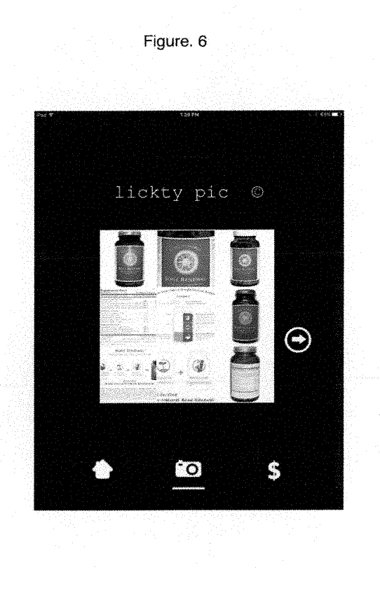

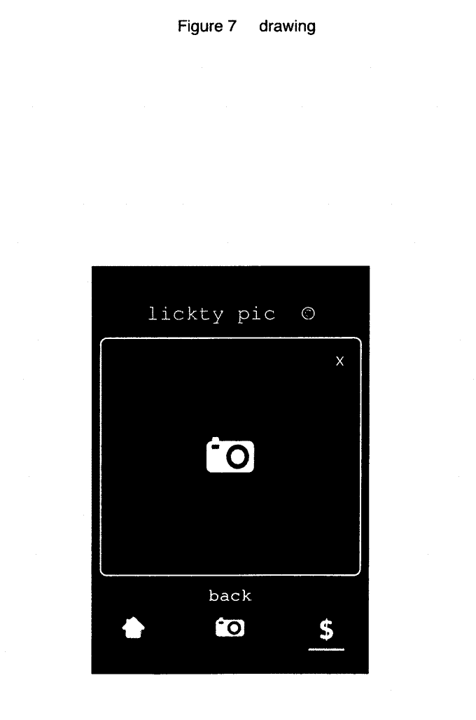

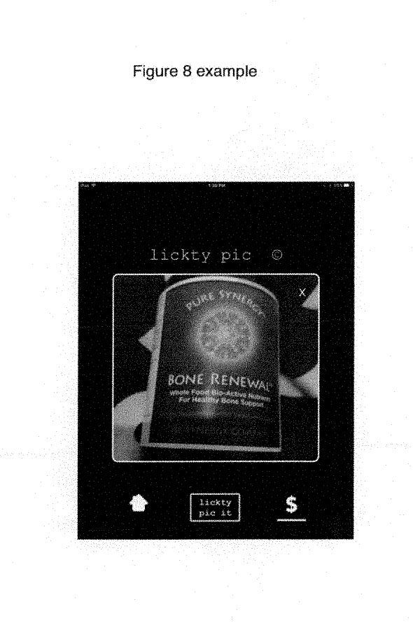

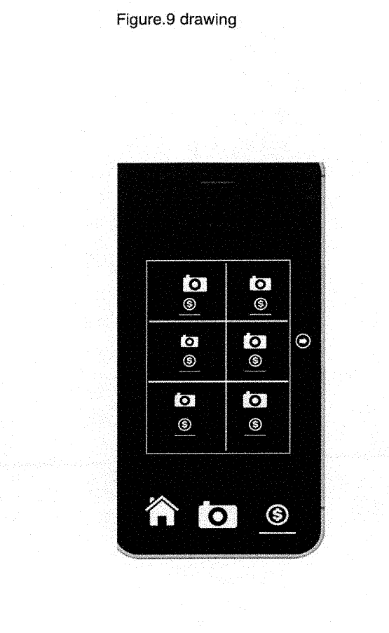

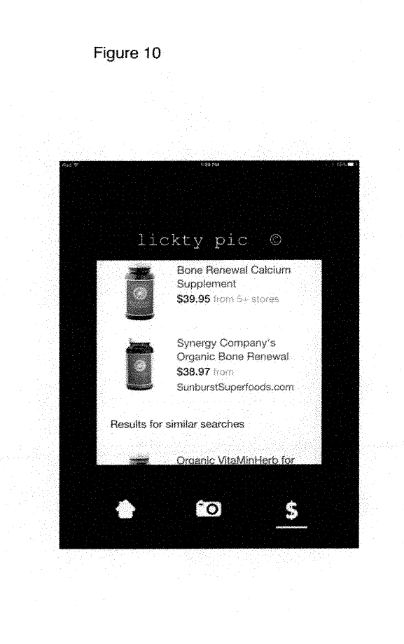

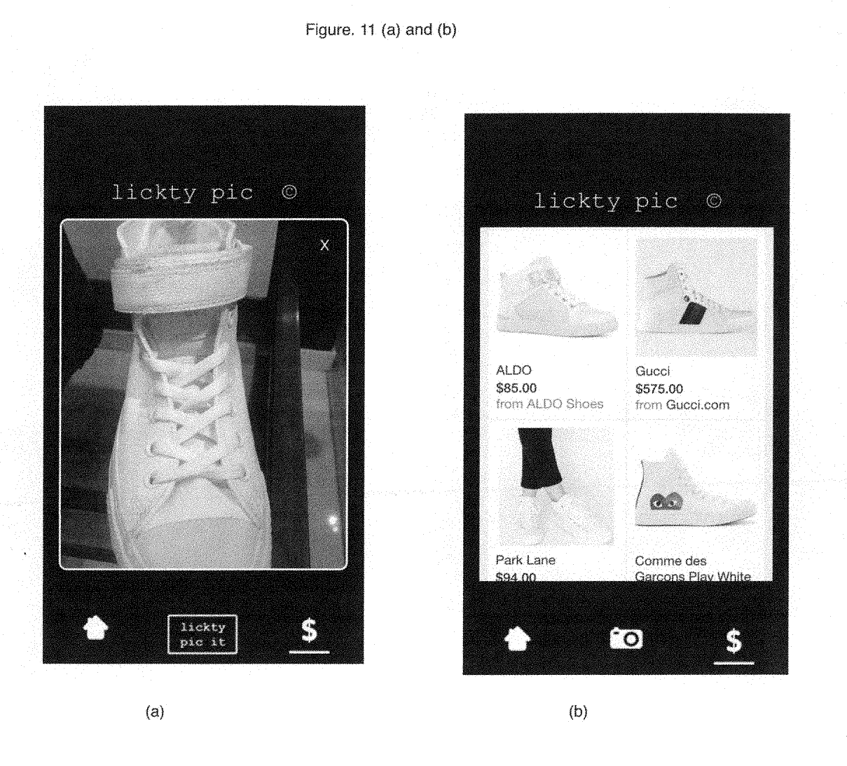

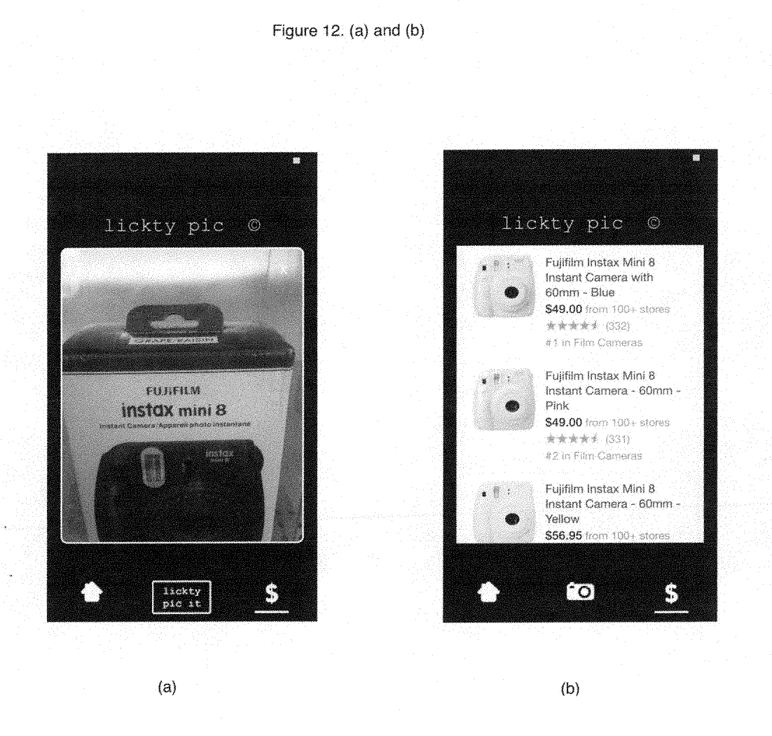

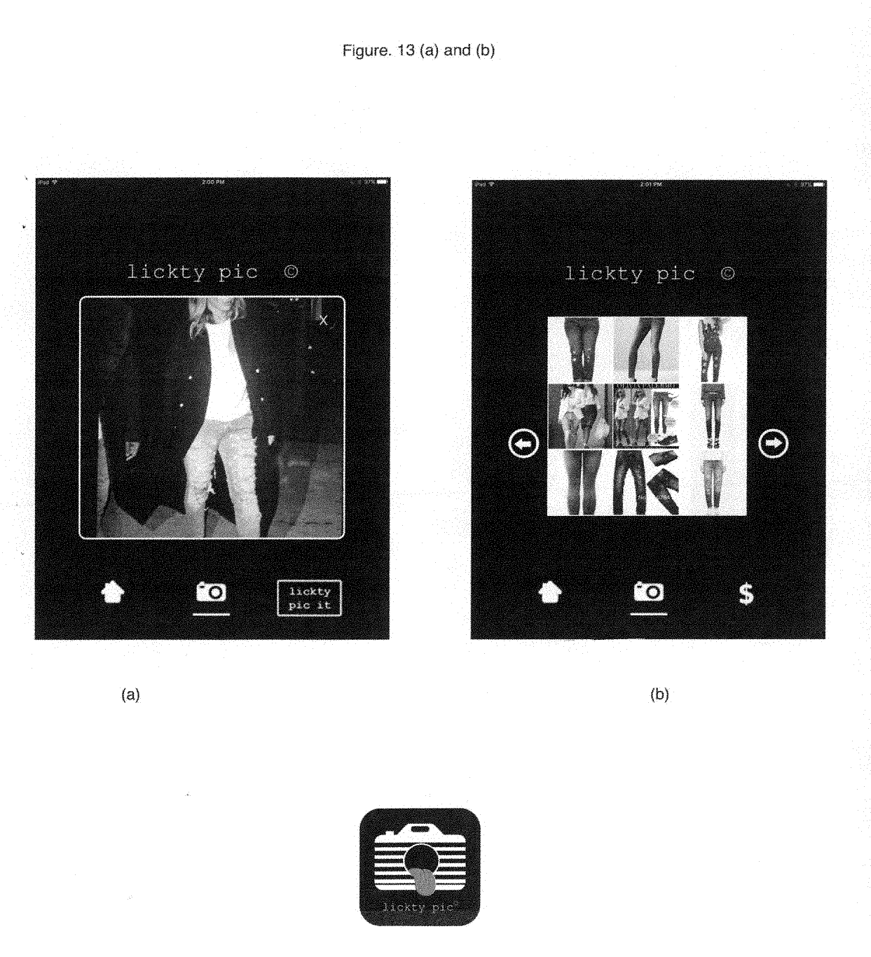

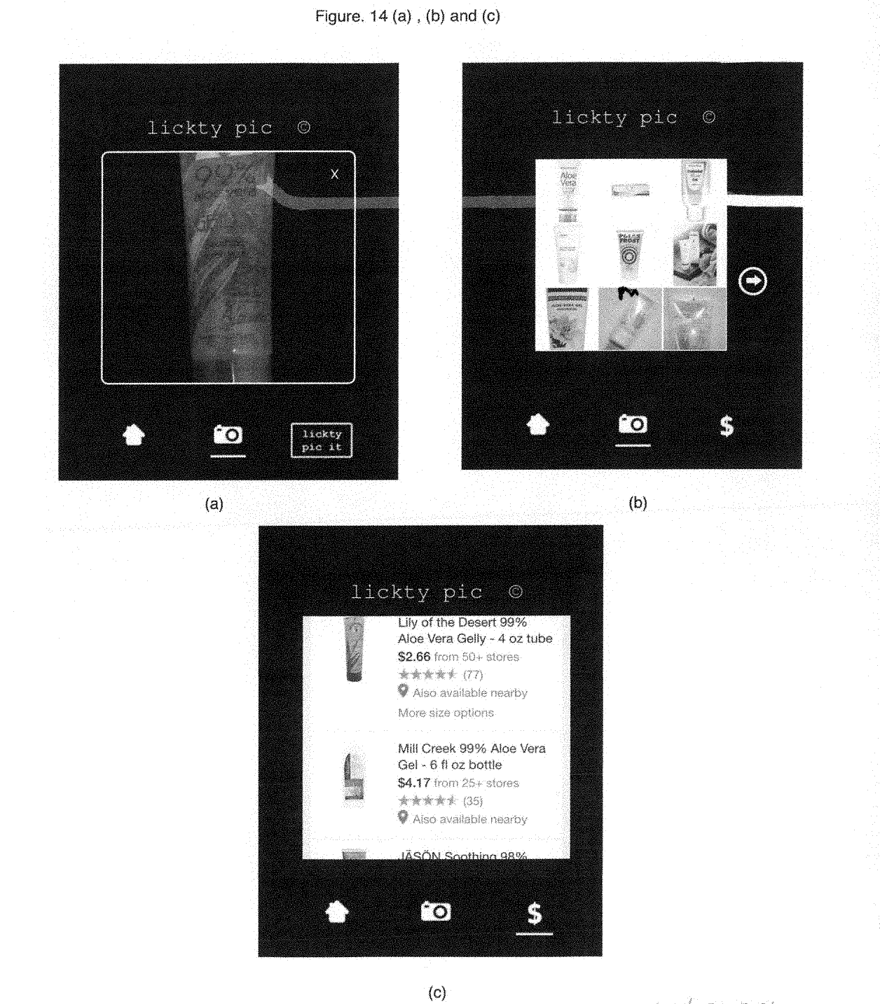

(the same vitamin—“bone renewal” I did a regular search option before) FIG. 4. Page 17, but now it's a $ icon (buy option), Then “licktypic it” (search button)

FIG. 9. Page 21

Results have come back with the same or very similar items (vitamin—bone renewal) can buy right now without have to search many websites.

FIG. 10. Page 22

### Example

Results have come back through Lickty pic with the same or very similar items (bone renewal vitamin) can buy right now for sale options of your image item/thing

“Bone renewal” vitamin results to buy

FIG. 11 (a) and (b). Page 23

Are another $ icon (buying search) examples

FIG. 11a. A pair of high top sneakers in a department store that did not have my size, I performed a buying search through my licktypic app and the results FIG. 11b. where better high top sneakers with option to buy these instead.

FIG. 12 (a) and (b) Page 24

### Example

(a) I found a Fuji instamax at bestbuy but thought it was overpriced I took a picture of it through Lickty pic $ buy option.
(b) And the results were cheaper

FIG. 13 (a) and (b) Page 25

### Regular Search Example

(a) Kim Kardashin ripped jeans I saw in a magazine

(b) Various image results of ripped jeans from websites

FIG. 14 (a), (b) and (c) Page 26

Examples of a regular search and a buy search of the same item/thing captured through Licktypic

(a). Aloe Vera gel

(b). Regular search

(c). Buy search

### DESCRIPTION

Licktypic app is no typing to search for what you want, instead you take a picture, licktypic will search for the exact or very similar image you have taken. You can then buy what you are looking at.

Licktypic has 2 options. A regular search of images, or strictly to buy the item you have taken a picture of.

using images as a search engine and also returning image results.

The purpose of my app lickty pic©, is to use solely an image you photograph to search the World Wide Web to bring back to you image of the exact item you searched for.
no typing
No lengthy descriptions of what you are looking for.
Simply take a photo lickty pic it© and get image results of your exact item you photographed

For a regular search.—which I use if I'm curious what this is or what other options there are that are similar to my thing/item. Or want more information on What I have taken a picture of

Licktypic gives you many picture results of your image you have taken, (licktypic pulls up the same or very similar items) you then click on each image to be transferred to that images website.

For a buying search.

FIG. 7. Page 19. You want to buy the same or similar item/thing you take a picture of:

Press the $ icon on the bottom

It then becomes underlined, your then prompted to take a picture.

Licktypic will pull up same or similar items you have taken a picture of that are for sale.

A good example is your vitamins you are looking for that you have taken a picture of, licktypic will pull up your brand and similar items to choose from.

Licktypic is what your eyes see and lets you choose from search information of the image (picture you have taken) or lets you buy what you have seen.

Licktypic uses image recognition—image to image search technology with the amazing feature of being able to strictly buy what you are looking at by taking a photograph of it, and results will be pulled up for sale that are similar or the same as your item/thing. Page 13 FIG. 1

1. What I claim as my invention is image to image search of the item you take a picture of, no typing
I claim take a photograph of anything through lickty pic, search for image results of your picture same or similar items to be displayed, no typing, no words image results appear. FIG. 1 page 13
I claim take a picture of your item/thing through Lickty pic and be able to buy it without typing and trying to describe what your looking at. FIG. 12 page 24
What I claim is what you see in physical form you can buy through Lickty pic using your phone camera as your eye to capture the item/thing in front of you and purchase or search information on about it. FIG. 1 page
I claim that, I see it, I take a photograph of it and I buy it. (Example FIG. 11 page. 23)
I claim I take a picture of the thing/item and can find same or similar images with information what it is. (Example FIG. 14 Page 0.26)
